(19) United States
(12) Patent Application Publication
(10) Pub. No.: US 2016/0163274 A1
(43) Pub. Date: Jun. 9, 2016

(54) METHOD OF CORRECTING SPOT, SPOT CORRECTING APPARATUS FOR PERFORMING THE METHOD AND DISPLAY APPARATUS HAVING THE SPOT CORRECTING APPARATUS

(71) Applicant: SAMSUNG DISPLAY CO., LTD., Yongin-si (KR)

(72) Inventors: Hoi-Sik MOON, Asan-si (KR); Byoung-Seok YOO, Seoul (KR)

(21) Appl. No.: 14/740,784

(22) Filed: Jun. 16, 2015

(30) Foreign Application Priority Data
Dec. 4, 2014 (KR) 10-2014-0173273

(51) Int. Cl. G09G 3/36

(52) U.S. Cl. CPC G09G 3/3611; G09G 2310/08; G09G 2320/0276; G09G 2320/0233; G09G 2310/027

(57) ABSTRACT

A spot correcting apparatus includes a first spot correcting part and a second spot correcting part. The first spot correcting part is configured to correct a first spot having a first size of a first correcting area unit of 2N*2N (N is a natural number) pixel area. The second spot correcting part is configured to correct a second spot having a second size different from the first size of a second correcting area unit of L*M (each of L and M is a natural number and at least one of L and M is different from 2N) pixel area. Thus, display quality of a display apparatus may be easily improved.

### CLAIM OF PRIORITY

This application claims the priority of and all the benefits accruing under 35 U.S.C. §119 to Korean Patent Application No. 10-2014-0173273, filed on Dec. 4, 2014 in the Korean Intellectual Property Office (KIPO), the contents of which are herein incorporated by reference in their entireties.

### BACKGROUND OF THE INVENTION

1. Field of Disclosure

Exemplary embodiments of the present inventive concept relate to a method of correcting a spot defect in a display panel (hereinafter “spot”), a spot correcting apparatus for performing the method, and a display apparatus having the spot correcting apparatus. More particularly, exemplary embodiments of the present inventive concept relate to a method of correcting a spot used in a display apparatus displaying an image, a spot correcting apparatus for performing the method, and a display apparatus having the spot correcting apparatus.

2. Description of the Related Art

A display apparatus such as a liquid crystal display apparatus includes a display panel and a display panel driving apparatus.

The display panel displays an image, and includes a gate line extending in a first direction, a data line extending in a second direction substantially perpendicular to the first direction, and a pixel defined by the gate line and the data line.

The display panel driving apparatus drives the display panel, and includes a gate driving part outputting a gate signal to the gate line, and a data driving part outputting a data signal to the data line.

However, a spot may be displayed on the display panel because of a phenomenon such as an electrical short circuit between a wiring line and an electrode formed in the display panel. Thus, display quality of the display apparatus may be degraded.

### SUMMARY OF THE INVENTION

Exemplary embodiments of the present inventive concept provide a method of correcting a spot capable of improving display quality of a display apparatus.

Exemplary embodiments of the present inventive concept also provide a spot correcting apparatus for performing the above-mentioned method.

Exemplary embodiments of the present inventive concept also provide a display apparatus having the above-mentioned spot correcting apparatus.

According to an exemplary embodiment of the present inventive concept, a method of correcting a spot includes correcting a first spot having a first size of a first correcting area unit of 2N*2N (N is a natural number) pixel area, and correcting a second spot having a second size different from the first size of a second correcting area unit of L*M (each of L and M is a natural number and at least one of L and M is different from 2N) pixel area.

In an exemplary embodiment, the first spot may have a first length longer than a length of 2N pixel area in a first direction.

In an exemplary embodiment, the first spot has a first width wider than a width of 2N pixel area in a second direction.

In an exemplary embodiment, the second size of the second spot may be less than the first size of the first spot, and the second size of the second spot may be less than a size of the 2N*2N pixel area.

In an exemplary embodiment, the second correcting area unit may include 2P*2P (P is a natural number different from N) pixel area, and the second spot may have a second length longer than a length of 2P pixel area in a first direction.

In an exemplary embodiment, the second correcting area unit may includes 2P*2P (P is a natural number different from N) pixel area, and the second spot may have a second width wider than a width of 2P pixel area in a second direction.

In an exemplary embodiment, the method may further include receiving an image data including the first spot and the second spot, receiving a first position data of the first spot and a second position data of the second spot, and receiving a first correcting area unit data of the first correcting area unit and a second correcting area unit data of the second correcting area unit.

In an exemplary embodiment, the first position data may designate a first center of the first spot and the second position data may designate a second center of the second spot.

In an exemplary embodiment, the first correcting area unit data may designate the first correcting area unit including four N*N pixel areas based on the first center of the first spot, and the second correcting area unit data may designate the second correcting area unit including four P*P (P is a natural number different from N) pixel areas based on the second center of the second spot.

In an exemplary embodiment, the first correcting area unit data may designate the first correcting area unit including four N*N pixel areas based on the first center of the first spot, and the second correcting area unit data may designate the second correcting area unit including four Q*R (Q corresponds to L/2, and R corresponds to M/2) pixel areas based on the second center of the second spot.

In an exemplary embodiment, the second size of the second spot may correspond to 1*V pixel area, and the second correcting area unit may correspond to the 1*V pixel area.

In an exemplary embodiment, a sampling point of a luminance profile of the second spot may be a peak point of a luminance profile curve.

In an exemplary embodiment, the method may further include storing input grayscale data and an output grayscale data in a lookup table.

In an exemplary embodiment, when an input grayscale of the input grayscale data is equal to or less than W grayscale which is a white grayscale, an output grayscale of the output grayscale data may be (the input grayscale−X (X is a natural number)) grayscale.

In an exemplary embodiment, the output grayscale data may further include (W−X)+1 to W grayscales.

According to an exemplary embodiment of the present inventive concept, a spot correcting apparatus includes a first spot correcting part and a second spot correcting part. The first spot correcting part is configured to correct a first spot having a first size of a first correcting area unit of 2N*2N (N is a natural number) pixel area. The second spot correcting part is configured to correct a second spot having a second size different from the first size of a second correcting area unit of L*M (each of L and M is a natural number and at least one of L and M is different from 2N) pixel area.

In an exemplary embodiment, the second size of the second spot may be less than the first size of the first spot, and the second size of the second spot may be less than a size of the 2N*2N pixel area.

In an exemplary embodiment, the second size of the second spot may correspond to 1*V pixel area, the second correcting area unit may correspond to the 1*V pixel area, and the second spot correcting part may include a lookup table storing an input grayscale data and an output grayscale data.

In an exemplary embodiment, when an input grayscale of the input grayscale data is equal to or less than W grayscale which is a white grayscale, an output grayscale of the output grayscale data may be (the input grayscale−X (X is a natural number)) grayscale, and the output grayscale data may further include (W−X)+1 to W grayscales.

According to an exemplary embodiment of the present inventive concept, a display apparatus a display panel, a gate driving part, a data driving part, a timing controlling part and a spot correcting apparatus. The display panel includes a gate line and a data line. The gate driving part is configured to output a gate signal to the gate line and drive the gate line. The data driving part is configured to output a data signal to the data line and drive the data line. The timing controlling part is configured to control a timing of the gate driving part and a timing of the data driving part. The spot correcting apparatus includes a first spot correcting part correcting a first spot displayed on the display panel and having a first size of a first correcting area unit of 2N*2N (N is a natural number) pixel area, and a second spot correcting part correcting a second spot displayed on the display panel and having a second size different from the first size of a second correcting area unit of L*M (each of L and M is a natural number and at least one of L and M is different from 2N) pixel area.

According to the present inventive concept, a spot correcting performance of spots having different sizes may be improved. In addition, a spot occurred owing to an electrical short circuit between a data line and a storage electrode and a spot occurred owing to an electrical short circuit between a data line and a shield electrode may be corrected without a repair such as a laser cutting. Thus, display quality of a display apparatus may be easily improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating a display apparatus according to an exemplary embodiment of the present inventive concept;

FIG. 2 is a plan view illustrating a display panel of FIG. 1;

FIG. 3 is an enlarged view illustrating a first spot of FIG. 2;

FIG. 4 is an enlarged view illustrating a second spot of FIG. 2;

FIG. 5 is a block diagram illustrating a spot correcting apparatus of FIG. 1;

FIG. 6 is a block diagram illustrating a first spot correcting data generating part of FIG. 5;

FIG. 7 is a block diagram illustrating a first spot correcting part of FIG. 5;

FIG. 8 is a block diagram illustrating a second spot correcting part of FIG. 5;

FIG. 9 is a block diagram illustrating a second spot correcting data generating part of FIG. 8;

FIGS. 10A, 10B and 10C are flow charts illustrating a method of correcting a spot performed by the spot correcting apparatus of FIG. 1;

FIG. 11 is a plan view illustrating a display panel according to an exemplary embodiment of the present inventive concept;

FIG. 12 is a block diagram illustrating a spot correcting apparatus which corrects a spot displayed on the display panel of FIG. 11;

FIG. 13 is a block diagram illustrating a spot correcting data generating part of FIG. 12;

FIG. 14 is a graph illustrating a luminance profile curve of a spot of FIG. 11;

FIG. 15 is a block diagram illustrating a spot correcting part of FIG. 12;

FIG. 16 is a chart illustrating a lookup table of FIG. 15; and

FIGS. 17A and 17B are flow charts illustrating a method of correcting a spot performed by the spot correcting apparatus of FIG. 12.

### DETAILED DESCRIPTION OF THE INVENTION

Hereinafter, the present inventive concept will be explained in detail with reference to the accompanying drawings.

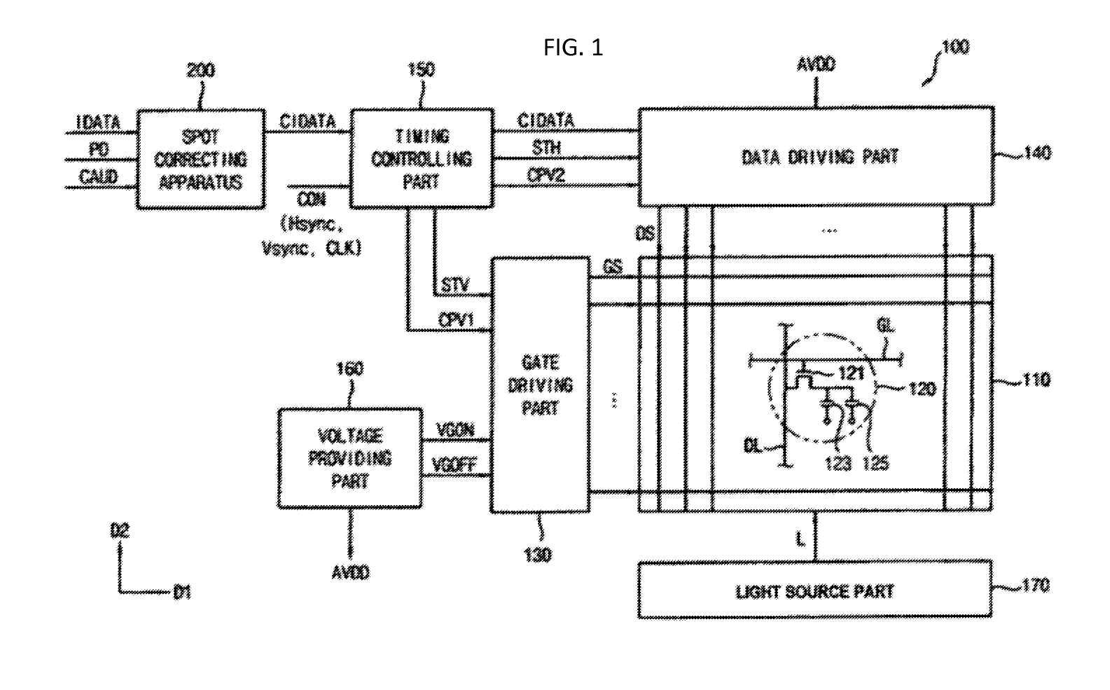

FIG. 1 is a block diagram illustrating a display apparatus according to an exemplary embodiment of the present inventive concept.

Referring to FIG. 1, the display apparatus 100 according to the present exemplary embodiment includes a display panel 110, a gate driving part 130, a data driving part 140, a timing controlling part 150, a voltage providing part 160, a light source part 170 and a spot correcting apparatus 200.

The display panel 110 receives a data signal DS based on a corrected image data CIDATA provided from the timing controlling part 150 to display an image. For example, the corrected image data CIDATA may be a two-dimensional plane image data. Alternatively, the corrected image data CIDATA may include a left-eye image data and a right-eye image data for displaying a three-dimensional stereoscopic image.

The display panel 110 includes gate lines GL, data lines DL and a plurality of pixels 120. The gate lines GL extend in a first direction D1 and are arranged in a second direction D2 substantially perpendicular to the first direction D1. The data lines DL extend in the second direction D2 and are arranged in the first direction D1. Each of the pixels 120 includes a thin film transistor 121 electrically connected to the gate line GL and the data line DL, a liquid crystal capacitor 123 and a storage capacitor 125 connected to the thin film transistor 121.

The gate driving part 130, the data driving part 140, the timing controlling part 150 and the voltage providing part 160 may be defined as a display panel driving apparatus driving the display panel 110.

The gate driving part 130 generates a gate signal GS in response to a gate start signal STV and a gate clock signal CLK1 provided from the timing controlling part 150, and outputs the gate signal GS to the gate line GL. The gate driving part 130 may generate the gate signal GS using a gate on voltage VGON and a gate off voltage VGOFF provided from the voltage providing part 160.

The data driving part 140 outputs a data signal DS to the data line DL in response to a data start signal STH and a data clock signal CLK2 provided from the timing controlling part 150. The data driving part 140 may output the data signal DS using a data driving voltage AVDD provided from the voltage providing part 160.

The timing controlling part 150 receives the corrected image data CIDATA from the spot correcting apparatus 200 and receives a control signal CON from an outside. The control signal CON may include a horizontal synchronous signal Hsync, a vertical synchronous signal Vsync and a clock signal CLK. The timing controlling part 150 generates the data start signal STH using the horizontal synchronous signal Hsync and outputs the data start signal STH to the data driving part 140. In addition, the timing controlling part 150 generates the gate start signal STV using the vertical synchronous signal Vsync and outputs the gate start signal STV to the gate driving part 130. In addition, the timing controlling part 150 generates the gate clock signal CLK1 and the data clock signal CLK2 using the clock signal CLK, outputs the gate clock signal CLK1 to the gate driving part 130, and outputs the data clock signal CLK2 to the data driving part 140.

The voltage providing part 160 outputs the gate on voltage VGON and the gate off voltage VGOFF to the gate driving part 130. In addition, the voltage providing part 160 outputs the data driving voltage AVDD to the data driving part 140.

The light source part 170 provides light L to the display panel 110.

The spot correcting apparatus 200 corrects a spot in the image which is displayed on the display panel 110. For example, the spot may be generated by the light source part 170. In addition, the spot may be generated by the display panel 110. In addition, the spot may be generated by the light source part 170 and the display panel 110.

The spot correcting apparatus 200 receives an image data IDATA, a position data PD and a correcting area unit data CAUD. The image data IDATA may be generated from the image displayed on the display panel 110. For example, the image data IDATA may be received from a camera (not shown) photographing the image which is displayed on the display panel 110. The position data PD is a data which designates a position of the spot. The correcting area unit data CAUD is a data designating a unit of an area where the spot is corrected.

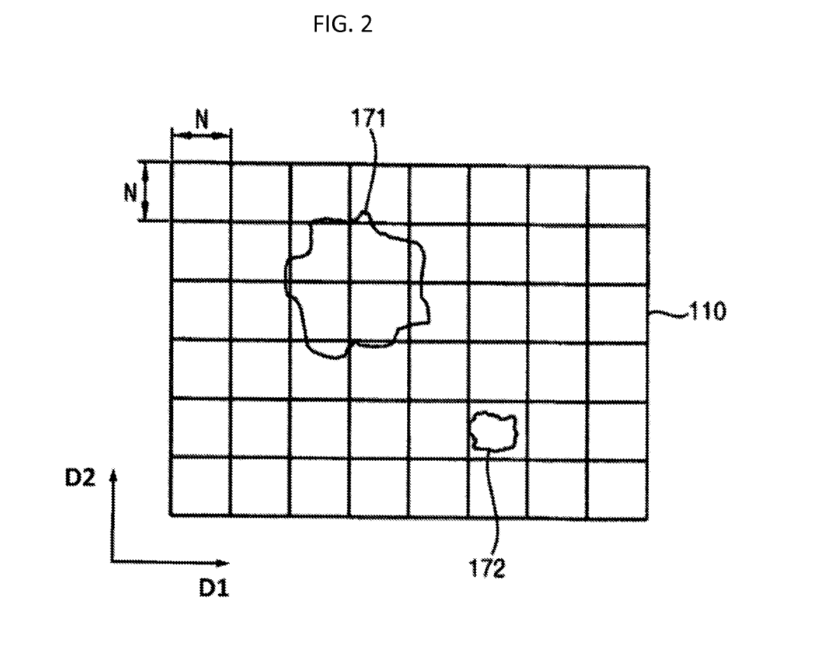

FIG. 2 is a plan view illustrating the display panel 110 of FIG. 1.

Referring to FIGS. 1 and 2, the display panel 110 may display a first spot 171 and a second spot 172.

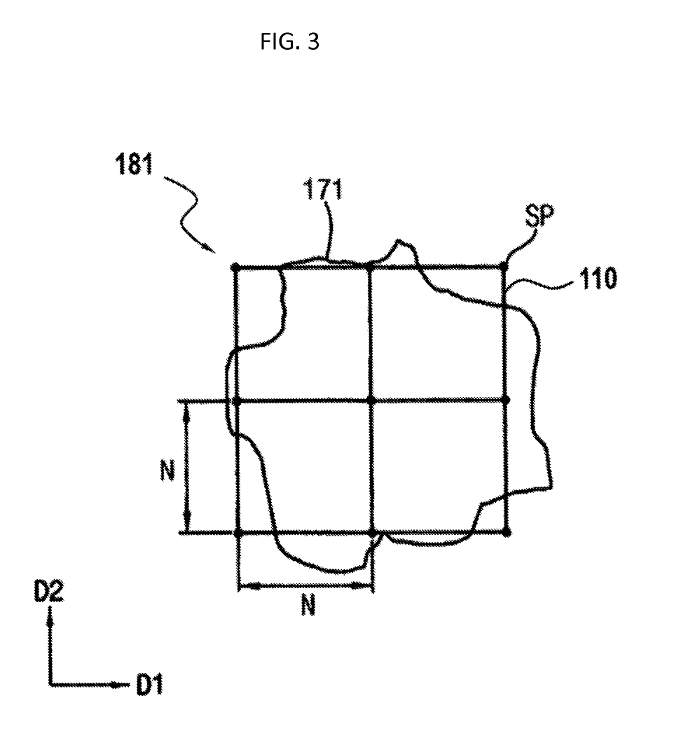

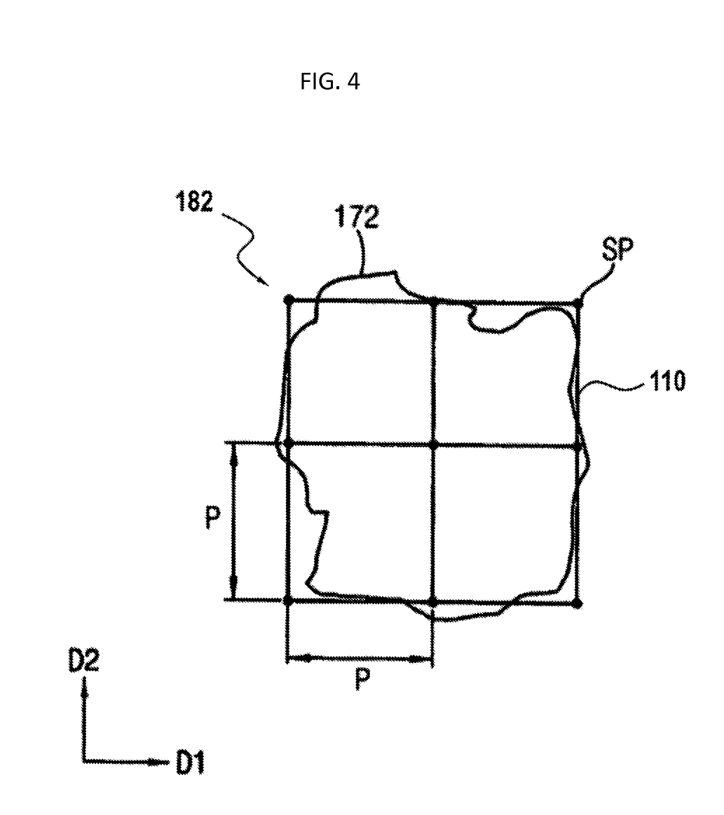

FIG. 3 is an enlarged view illustrating the first spot 171 of FIG. 2. FIG. 4 is an enlarged view illustrating the second spot 172 of FIG. 2.

Referring to FIGS. 1 to 4, the first spot 171 has a first length longer than a length of 2N (N is a natural number) pixel area in the first direction D1 and a first width wider than a width of the 2N pixel area in the second direction D2. In this case, the first spot 171 may be corrected by a first correcting area unit 181 of 2N*2N pixel area. The first correcting area unit 181 may include four N*N pixel areas based on a center of the first spot 171. Here, 1*1 pixel area of the N*N pixel area may be a group of sub pixels such as a red pixel, a green pixel and a blue pixel. Alternatively, the 1*1 pixel area may include at least one of the sub pixels such as the red pixel, the green pixel and the blue pixel.

In addition, the first correcting area unit 181 may include nine sampling points SP where a luminance profile of the first spot 171 is extracted. For example, the first correcting area unit 181 may include three sampling points SP where the luminance profile of the first spot 171 is extracted in the first direction D1, and may include three sampling points SP where the luminance profile of the first spot 171 is extracted in the second direction D2.

A size of the second spot 172 is less than that of the first spot 171. Specifically, the second spot 172 has a second length shorter than the length of the 2N pixel area in the first direction D1 and a second width narrower than the width of the 2N pixel area in the second direction D2. In this case, when the second spot 172 is corrected by the first correcting area unit 181, a correcting performance may decrease, and thus the second spot 172 may be corrected by the second correcting area unit 182 of 2P*2P (P is a natural number less than N) pixel area. The second correcting area unit 182 may include four P*P pixel areas based on a center of the second spot 172. In addition, the second correcting area unit 182 may include nine sampling points SP where a luminance profile of the second spot 172 is extracted. For example, the second correcting area unit 182 may include three sampling points SP where the luminance profile of the second spot 172 is extracted in the first direction D1, and may include three sampling points SP where the luminance profile of the second spot 172 is extracted in the second direction D2.

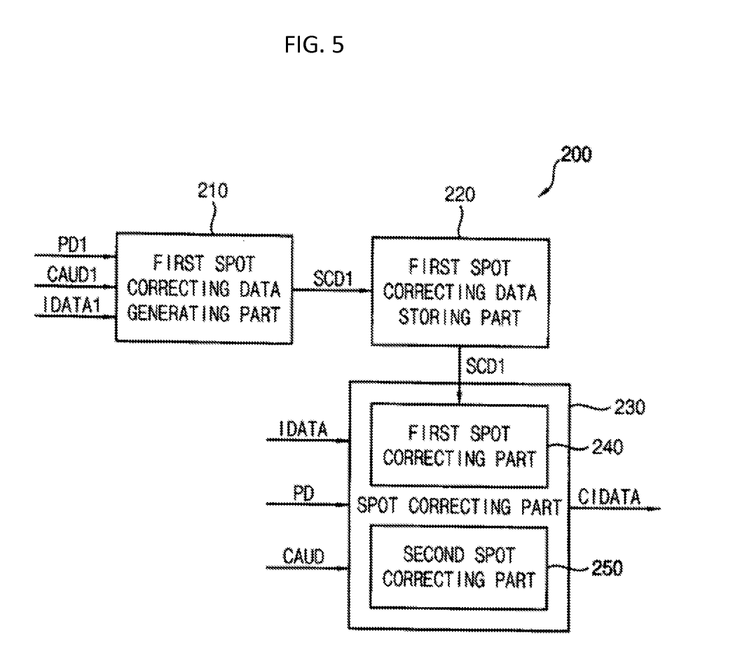

FIG. 5 is a block diagram illustrating the spot correcting apparatus 200 of FIG. 1.

Referring to FIGS. 1 to 5, the spot correcting apparatus 200 may include a first spot correcting data generating part 210, a first spot correcting data storing part 220 and a spot correcting part 230.

The first spot correcting data generating part 210 receives a first position data PD1 among the position data PD, a first correcting area unit data CAUD1 among the correcting area unit data CAUD and a first image data IDATA1 among the image data IDATA. The first position data PD1 designates a position of the first spot 171. The first correcting area unit data CAUD1 designates a correcting area unit of the first spot 171. The first image data IDATA1 includes the first spot 171. The first spot correcting data generating part 210 outputs a first spot correcting data SCD1 using the first position data PD1, the first correcting area unit data CAUD1 and the first image data IDATA1. The first spot correcting data SCD1 is a data for correcting the first spot 171.

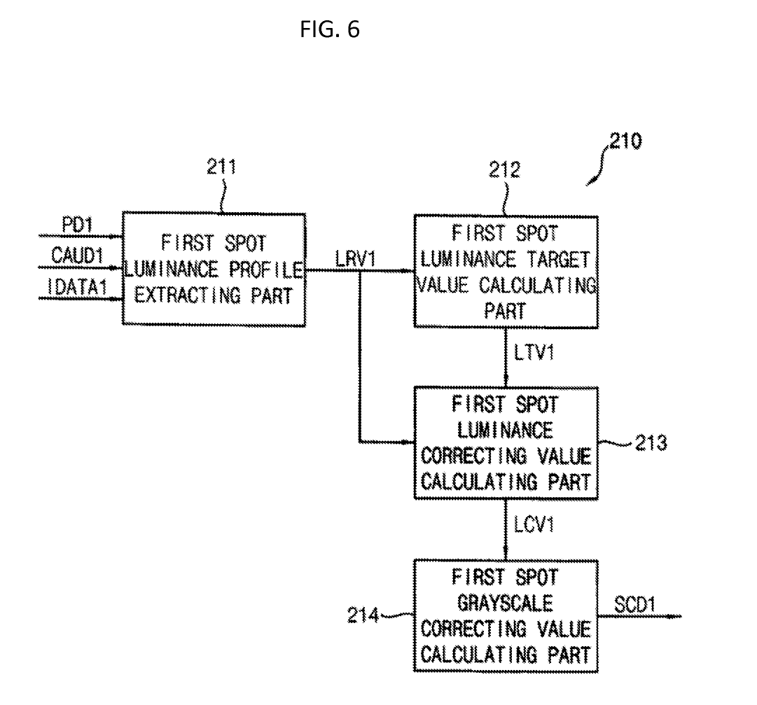

FIG. 6 is a block diagram illustrating the first spot correcting data generating part 210 of FIG. 5.

Referring to FIGS. 1 to 6, the first spot correcting data generating part 210 includes a first spot luminance profile extracting part 211, a first spot luminance target value calculating part 212, a first spot luminance correcting value calculating part 213 and a first spot grayscale correcting value calculating part 214.

The first spot luminance profile extracting part 211 receives the first position data PD1, the first correcting area unit data CAUD1 and the first image data IDATA1, extracts the luminance profile of the first spot 171, and output a first luminance representative value LRV1 of the first spot 171. The first luminance representative value LRV1 may be determined as one of a luminance average value, a luminance maximum value and a luminance minimum value at the sampling points SP of the first spot 171.

The first spot luminance target value calculating part 212 outputs a first luminance target value LTV1 of the first spot 171 using the first luminance representative value LRV1 and through a two-dimensional fitting algorithm.

The first spot luminance correcting value calculating part 213 receives the first luminance target value LTV1 and the first luminance representative value LRV1, calculates a difference between the first luminance target value LTV1 and the first luminance representative value LRV1 as a first luminance correcting value LCV1 of the first spot 171, and outputs the first luminance correcting value LCV1.

The first spot grayscale correcting value calculating part 214 outputs the first spot correcting data SCD1 corresponding to the first luminance correcting value LCV1 using a gamma curve. Thus, the first spot correcting data SCD1 may be a first grayscale correcting value of the first spot 171. The first spot correcting data SCD1 may include a correcting data for K (K is a natural number not less than two) reference grayscales. For example, the reference grayscales may be 16 grayscales, 24 grayscales, 32 grayscales, 64 grayscales, 128 grayscales, 160 grayscales, 192 grayscales, 224 grayscales and 255 grayscales.

Referring to FIGS. 1 to 5 again, the first spot correcting data storing part 220 stores the first spot correcting data SCD1. For example, the first spot correcting data storing part 220 may be a Synchronous Dynamic Random Access Memory (SDRAM). Alternatively, the first spot correcting data storing part 220 may be an Electrically Erasable Programmable Read-Only Memory (EEPROM). Thus, the first spot correcting data storing part 220 may be a nonvolatile memory. The first spot correcting data storing part 220 stores a correcting data for the K reference grayscales, and thus a data capacity of the first spot correcting data storing part 220 may be decreased.

The spot correcting part 230 receives the image data IDATA, the position data PD and the correcting area unit data CAUD to correct the first spot 171 and the second spot 172. The spot correcting part 230 may include a first spot correcting part 240 for correcting the first spot 171 and a second spot correcting part 250 for correcting the second spot 172.

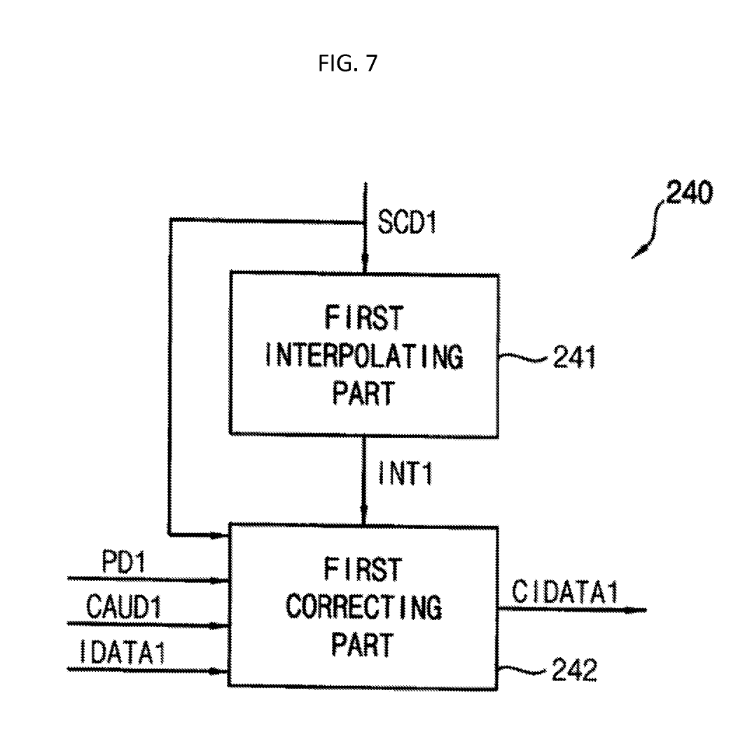

FIG. 7 is a block diagram illustrating the first spot correcting part 240 of FIG. 5.

Referring to FIGS. 1 to 7, the first spot correcting part 240 includes a first interpolating part 241 and a first correcting part 242.

The first interpolating part 241 receives the first spot correcting data SCD1 and outputs a first interpolating data INT1. Specifically, the first interpolating part 241 outputs a correcting data for grayscales not the K reference grayscales using the correcting data for the K reference grayscales with an interpolation method.

The first correcting part 242 receives the first image data IDATA1 including the first spot 171, the first position data PD1 designating the position of the first spot 171, the first correcting area unit data CAUD1 of the first spot 171, the first spot correcting data SCD1 and the first interpolating data INT1, corrects the first spot 171 using the first position data PD1, the first correcting area unit data CAUD1, the first spot correcting data SCD1 and the first interpolating data INT1, and outputs a first corrected image data CIDATA1 generated by correcting the first spot 171. The first corrected image data CIDATA1 may be in the corrected image data CIDATA.

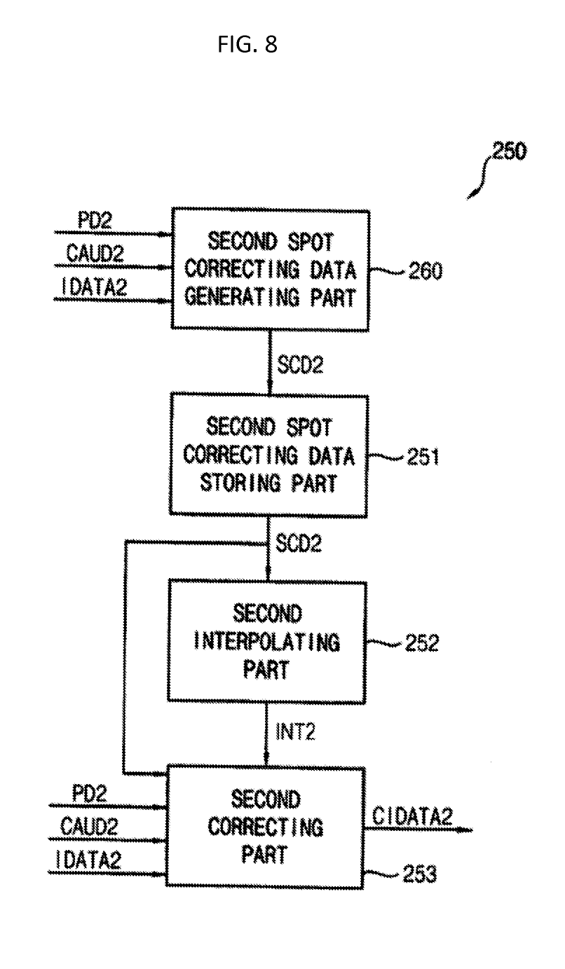

FIG. 8 is a block diagram illustrating the second spot correcting part 250 of FIG. 5.

Referring to FIGS. 1 to 8, the second spot correcting part 250 includes a second spot correcting data generating part 260, a second spot correcting data storing part 251, a second interpolating part 252 and a second correcting part 253.

The second spot correcting data generating part 260 receives a second position data PD2 among the position data PD, a second correcting area unit data CAUD2 among the correcting area unit data CAUD and a second image data IDATA2 among the image data IDATA. The second position data PD2 designates a position of the second spot 172. The second correcting area unit data CAUD2 designates a correcting area unit of the second spot 172. The second image data IDATA2 includes the second spot 172. The second spot correcting data generating part 260 outputs a second spot correcting data SCD2 using the second position data PD2, the second correcting area unit data CAUD2 and the second image data IDATA2. The second spot correcting data SCD2 is a data for correcting the second spot 172.

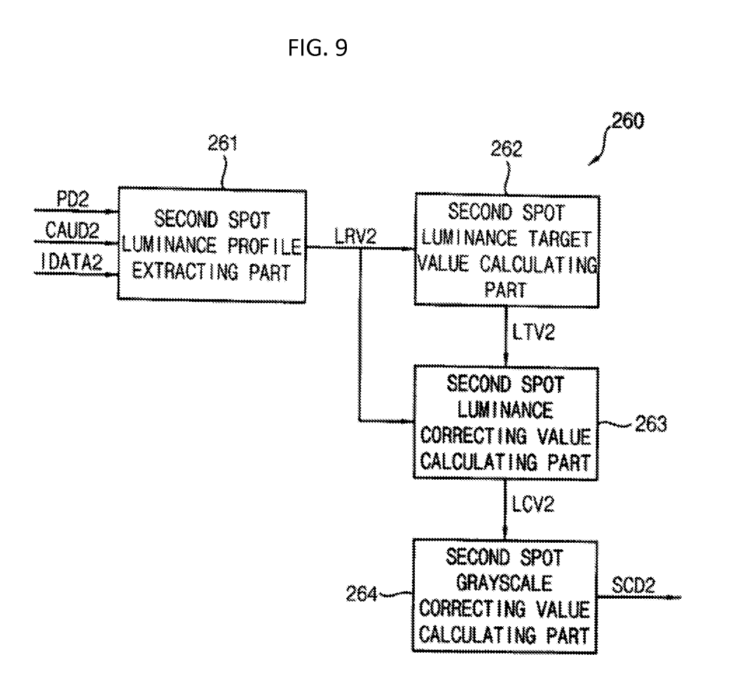

FIG. 9 is a block diagram illustrating the second spot correcting data generating part 260 of FIG. 8.

Referring to FIGS. 1 to 9, the second spot correcting data generating part 260 includes a second spot luminance profile extracting part 261, a second spot luminance target value calculating part 262, a second spot luminance correcting value calculating part 263 and a second spot grayscale correcting value calculating part 264.

The second spot luminance profile extracting part 261 receives the second position data PD2, the second correcting area unit data CAUD2 and the second image data IDATA2, extracts the luminance profile of the second spot 172, and output a second luminance representative value LRV2 of the second spot 172. The second luminance representative value LRV2 may be determined as one of a luminance average value, a luminance maximum value and a luminance minimum value at the sampling points SP of the second spot 172.

The second spot luminance target value calculating part 262 outputs a second luminance target value LTV2 of the second spot 172 using the second luminance representative value LRV2 and through a two-dimensional fitting algorithm.

The second spot luminance correcting value calculating part 263 receives the second luminance target value LTV2 and the second luminance representative value LRV2, calculates a difference between the second luminance target value LTV2 and the second luminance representative value LRV2 as a second luminance correcting value LCV2 of the second spot 172, and outputs the second luminance correcting value LCV2.

The second spot grayscale correcting value calculating part 264 outputs the second spot correcting data SCD2 corresponding to the second luminance correcting value LCV2 using a gamma curve. Thus, the second spot correcting data SCD2 may be a second grayscale correcting value of the second spot 172. The second spot correcting data SCD2 may include a correcting data for K (K is a natural number not less than two) reference grayscales. For example, the reference grayscales may be 16 grayscales, 24 grayscales, 32 grayscales, 64 grayscales, 128 grayscales, 160 grayscales, 192 grayscales, 224 grayscales and 255 grayscales.

Referring to FIGS. 1 to 8 again, the second spot correcting data storing part 251 stores the second spot correcting data SCD2. For example, the second spot correcting data storing part 251 may be a Synchronous Dynamic Random Access Memory (SDRAM). Alternatively, the second spot correcting data storing part 251 may be an Electrically Erasable Programmable Read-Only Memory (EEPROM). Thus, the second spot correcting data storing part 251 may be a nonvolatile memory. The second spot correcting data storing part 251 stores a correcting data for K reference grayscales, and thus a data capacity of the second spot correcting data storing part 251 may be decreased.

The second interpolating part 252 receives the second spot correcting data SCD2 and outputs a second interpolating data INT2. Specifically, the second interpolating part 252 outputs a correcting data for grayscales not the K reference grayscales using the correcting data for the K reference grayscales with an interpolation method.

The second correcting part 253 receives the second image data IDATA2 including the second spot 172, the second position data PD2 designating the position of the second spot 172, the second correcting area unit data CAUD2 of the second spot 172, the second spot correcting data SCD2 and the second interpolating data INT2, corrects the second spot 172 using the second position data PD2, the second correcting area unit data CAUD2, the second spot correcting data SCD2 and the second interpolating data INT2, and outputs a second corrected image data CIDATA2 generated by correcting the second spot 172. The second corrected image data CIDATA2 may be in the corrected image data CIDATA.

In the present exemplary embodiment, the first spot correcting data generating part 210 and the first spot correcting data storing part 220 are disposed outside the first spot correcting part 240, but are not limited thereto. For example, at least one of the first spot correcting data generating part 210 and the first spot correcting data storing part 220 may be in the first spot correcting part 240.

In addition, in the present exemplary embodiment, the second spot correcting data generating part 260 and the second spot correcting data storing part 251 are disposed in the second spot correcting part 250, but are not limited thereto. For example, at least one of the second spot correcting data generating part 260 and the second spot correcting data storing part 251 may be outside the second spot correcting part 250.

In addition, in the present exemplary embodiment, the spot correcting apparatus 200 is disposed outside the timing controlling part 150, but is not limited thereto. For example, the spot correcting apparatus 200 may be in the timing controlling part 150.

In addition, in the present exemplary embodiment, the second correcting area unit 182 includes the four P*P pixel areas, but is not limited thereto. For example, when the second spot 172 has a length longer than a length of 2Q pixel area in the first direction D1 and a width wider than a width of 2R pixel area in the second direction D2 (here, each of Q and R is a natural number and at least one of Q and R is different from N), the second correcting area unit 182 may include four Q*R pixel areas. In this case, the second correcting area unit 182 may have L*M (L equals to 2Q and M equals to 2R) pixel area.

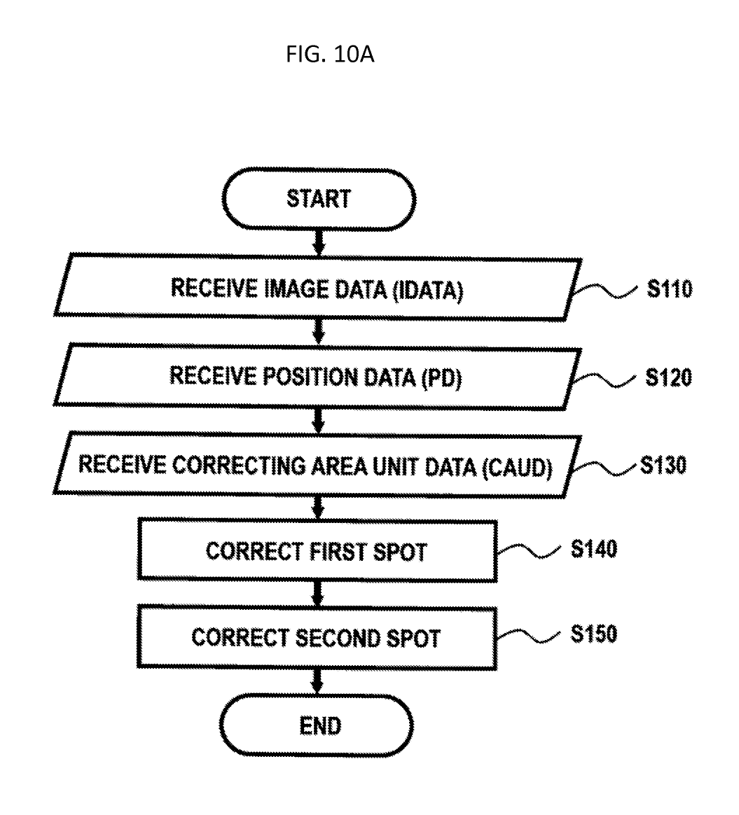

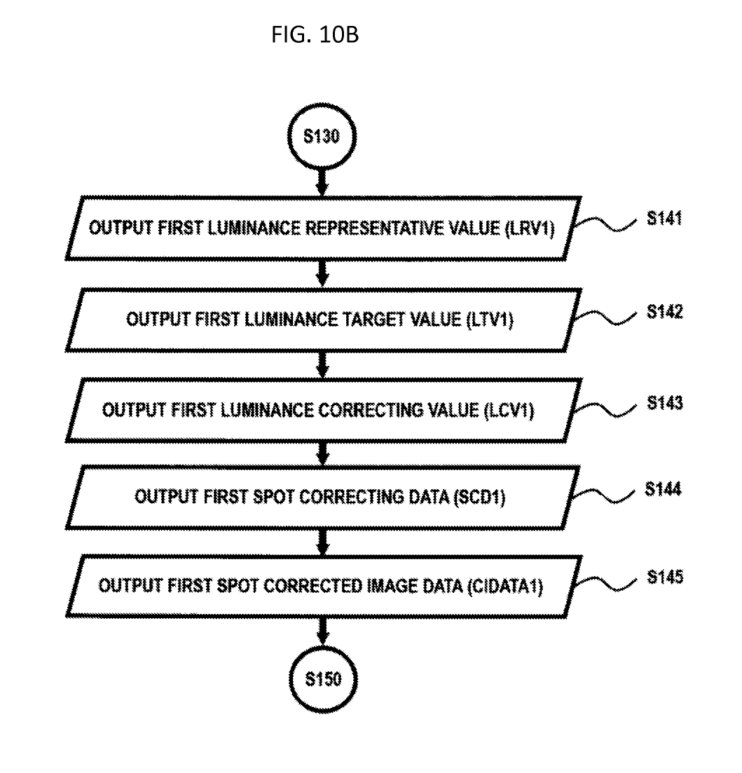

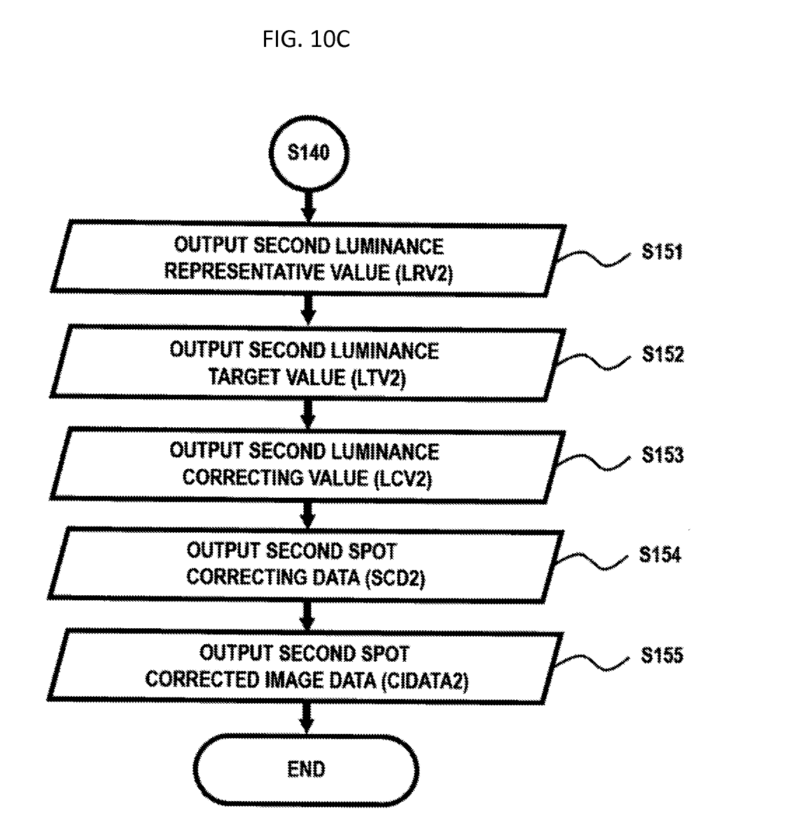

FIGS. 10A, 10B and 10C are flow charts illustrating a method of correcting a spot performed by the spot correcting apparatus 200 of FIG. 1.

Referring to FIGS. 1 to 10C, the image data IDATA is received (step S110). Specifically, the spot correcting apparatus 200 receives the image data IDATA including the first spot 171 and the second spot 172.

The position data PD is received (step S120). Specifically, the spot correcting apparatus 200 receives the first position data PD1 of the first spot 171 and the second position data PD2 of the second spot 172. The first position data PD1 may designate the position of the first spot 171 and the second position data PD2 may designate the position of the second spot 172.

The correcting area unit data CAUD is received (step S130). Specifically, the spot correcting apparatus 200 receives the first correcting area unit data CAUD1 of the first correcting area unit 181 and the second correcting area unit data CAUD2 of the second correcting area unit 182.

The first spot 171 is corrected (step S140).

Specifically, the first spot luminance profile extracting part 211 extracts the luminance profile of the first spot 171 using the first position data PD1, the first correcting area unit data CAUD1 and the first image data IDATA1, and outputs the first luminance representative value LRV1 of the first spot 171 (step S141).

The first spot luminance target value calculating part 212 outputs the first luminance target value LTV1 of the first spot 171 using the first luminance representative value LRV1 and through the two-dimensional fitting algorithm (step S142).

The first spot luminance correcting value calculating part 213 receives the first luminance target value LTV1 and the first luminance representative value LRV1, calculates the difference between the first luminance target value LTV1 and the first luminance representative value LRV1 as the first luminance correcting value LCV1 of the first spot 171, and outputs the first luminance correcting value LCV1 (step S143).

The first spot grayscale correcting value calculating part 214 outputs the first spot correcting data SCD1 corresponding to the first luminance correcting value LCV1 using the gamma curve. The first spot correcting data SCD1 may be the first grayscale correcting value of the first spot 171. The first spot correcting data SCD1 may include the correcting data for the K (K is a natural number not less than two) reference grayscales.

The first corrected image data CIDATA1 is output (step S145). Specifically, the first interpolating part 241 receives the first spot correcting data SCD1 and outputs the first interpolating data INT1 which is the correcting data for the grayscales not the K reference grayscales in the interpolation method. The first correcting part 242 corrects the first spot 171 using the first position data PD1, the first correcting area unit data CAUD1, the first spot correcting data SCD1 and the first interpolating data INT1, and outputs the first corrected image data CIDATA1 generated by correcting the first spot 171.

The second spot 172 is corrected (step S150).

Specifically, the second spot luminance profile extracting part 261 extracts the luminance profile of the second spot 172 using the second position data PD2, the second correcting area unit data CAUD2 and the second image data IDATA2, and outputs the second luminance representative value LRV2 of the second spot 172 (step S151).

The second spot luminance target value calculating part 262 outputs the second luminance target value LTV2 of the second spot 172 using the second luminance representative value LRV2 and through the two-dimensional fitting algorithm (step S152).

The second spot luminance correcting value calculating part 263 receives the second luminance target value LTV2 and the second luminance representative value LRV2, calculates the difference between the second luminance target value LTV2 and the second luminance representative value LRV2 as the second luminance correcting value LCV2 of the second spot 172, and outputs the second luminance correcting value LCV2 (step S153).

The second spot grayscale correcting value calculating part 264 outputs the second spot correcting data SCD2 corresponding to the second luminance correcting value LCV2 using the gamma curve. The second spot correcting data SCD2 may be the second grayscale correcting value of the second spot 172. The second spot correcting data SCD2 may include the correcting data for the K (K is a natural number not less than two) reference grayscales.

The second corrected image data CIDATA2 is output (step S155). Specifically, the second interpolating part 252 receives the second spot correcting data SCD2 and outputs the second interpolating data INT2 which is the correcting data for the grayscales not the K reference grayscales in the interpolation method. The second correcting part 253 corrects the second spot 172 using the second position data PD2, the second correcting area unit data CAUD2, the second spot correcting data SCD2 and the second interpolating data INT2, and outputs the second corrected image data CIDATA2 generated by correcting the second spot 172.

According to the present exemplary embodiment, since the first spot 171 having a first size is corrected by the first correcting area unit of the 2N*2N pixel area and the second spot 172 having a second size less than the first size is corrected by the second correcting area unit of the 2P*2P pixel area, a spot correcting performance of the image data IDATA including the first spot 171 and the second spot 172 may be improved. Thus, display quality of the display apparatus 100 may be improved.

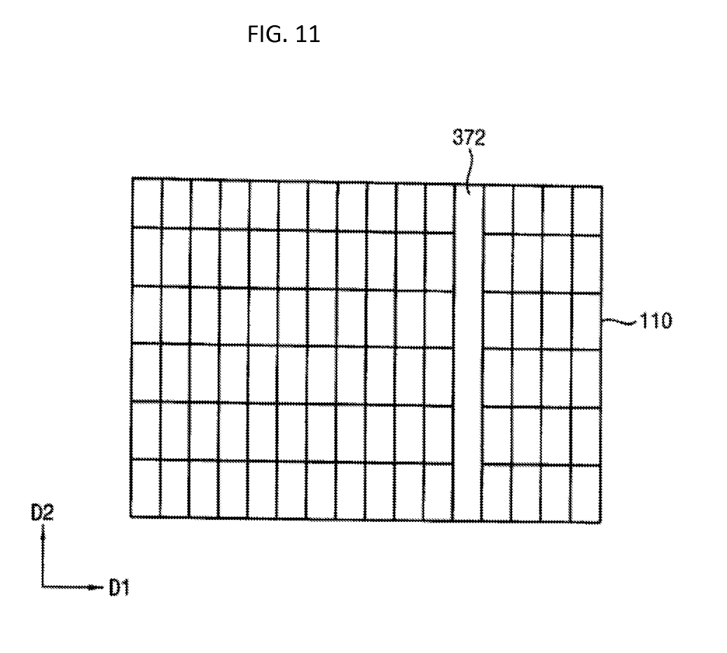

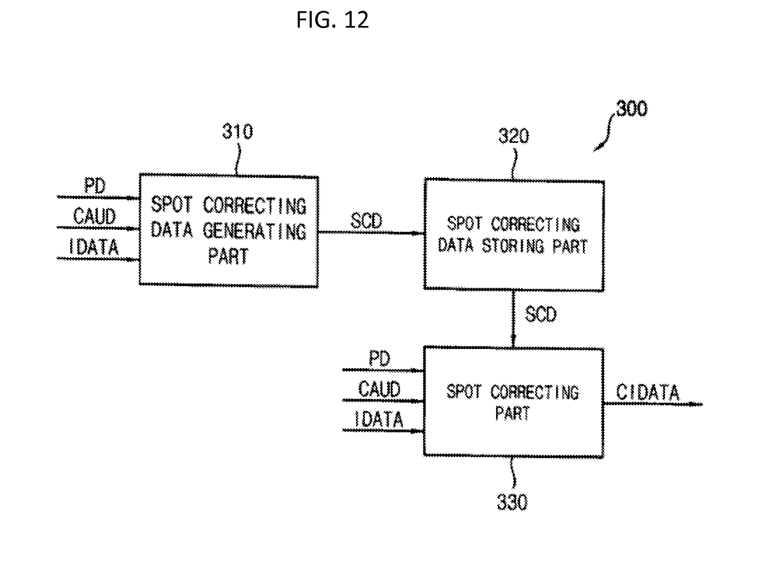

FIG. 11 is a plan view illustrating a display panel according to an exemplary embodiment of the present inventive concept. FIG. 12 is a block diagram illustrating a spot correcting apparatus which corrects a spot 372 displayed on the display panel 110 of FIG. 11.

The display panel 110 according to the present exemplary embodiment may be substantially the same as the display panel according to the previous exemplary embodiment illustrated in FIG. 1. In addition, the spot correcting apparatus 300 according to the present exemplary embodiment may be in the display apparatus 100 according to the previous exemplary embodiment illustrated in FIG. 1. Specifically, the spot correcting apparatus 300 according to the present exemplary embodiment may replace the spot correcting apparatus 200 according to the previous exemplary embodiment illustrated in FIG. 1. Alternatively, the spot correcting apparatus 300 according to the present exemplary embodiment may be in the spot correcting apparatus 200 according to the previous exemplary embodiment illustrated in FIG. 1. In this case, the spot correcting apparatus 300 according to the present exemplary embodiment may be in the second spot correcting part 250 of the spot correcting apparatus 200 according to the previous exemplary embodiment illustrated in FIG. 1. Thus, the same reference numerals may be used to refer to same or like parts as those described in the previous exemplary embodiment and any further repetitive explanation concerning the above elements may be omitted.

Referring to FIGS. 1 and 11, the display panel 110 may display the spot 372. For example, the spot 372 may correspond to 1*V pixel area, and in this case, a correcting area unit in which the spot 372 is corrected may correspond to the 1*V pixel area. In addition, for example, the spot 372 may be generated due to an electrical short circuit between the data line DL and a storage electrode. In addition, the spot 372 may be generated due to an electrical short circuit between the data line DL and a shield electrode.

Referring to FIG. 12, the spot correcting apparatus 300 includes a spot correcting data generating part 310, a spot correcting data storing part 320 and a spot correcting part 330.

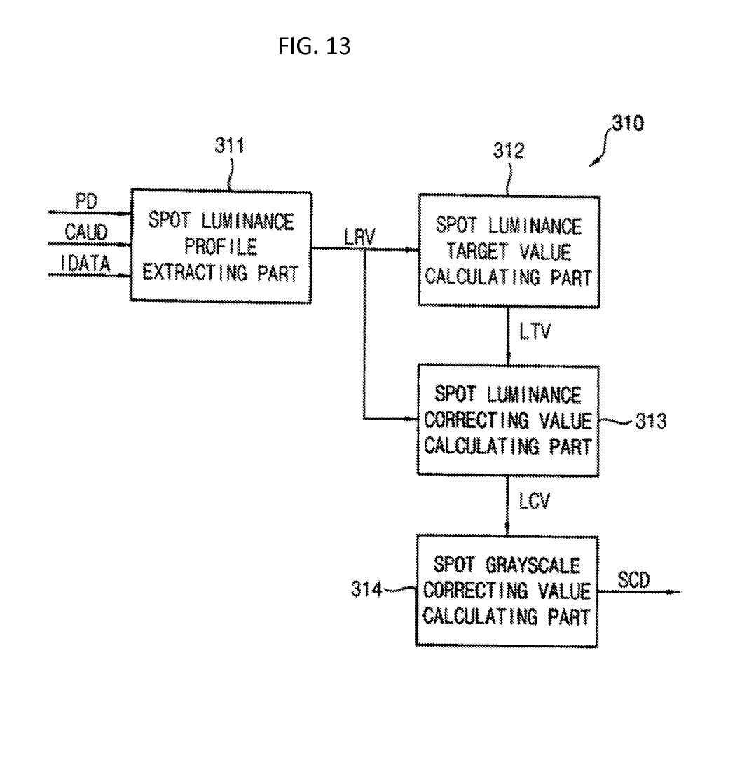

FIG. 13 is a block diagram illustrating the spot correcting data generating part 310 of FIG. 12.

Referring to FIGS. 12 and 13, the spot correcting data generating part 310 includes a spot luminance profile extracting part 311, a spot luminance target value calculating part 312, a spot luminance correcting value calculating part 313 and a spot grayscale correcting value calculating part 314.

The spot luminance profile extracting part 311 receives a position data PD designating a position of the spot 372, a correcting area unit data CAUD of the spot 372 and an image data IDATA including the spot 372 to extract a luminance profile of the spot 372, and outputs a luminance representative value LRV of the spot 372.

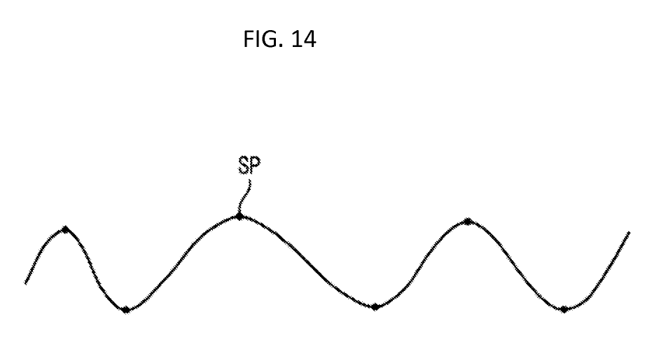

FIG. 14 is a graph illustrating a luminance profile curve of the spot 372 of FIG. 11.

Referring to FIGS. 11 to 14, the sampling points SP of the spot 372 may be set as peak points in the luminance profile curve of the spot 372. The luminance representative value LRV may be determined as one of a luminance average value, a luminance maximum value and a luminance minimum value at the sampling points SP of the spot 372.

Referring to FIGS. 11 to 13 again, the spot luminance target value calculating part 312 outputs a luminance target value LTV of the spot 372 using the luminance representative value LRV and through a two-dimensional fitting algorithm.

The spot luminance correcting value calculating part 313 receives the luminance target value LTV and the luminance representative value LRV, calculates a difference between the luminance target value LTV and the luminance representative value LRV as a luminance correcting value LCV of the spot 372, and outputs the luminance correcting value LCV.

The spot grayscale correcting value calculating part 314 outputs the spot correcting data SCD corresponding to the luminance correcting value LCV using a gamma curve. Thus, the spot correcting data SCD may be a grayscale correcting value of the spot 372. The spot correcting data SCD may include a correcting data for K (K is a natural number not less than two) reference grayscales. For example, the reference grayscales may be 16 grayscales, 24 grayscales, 32 grayscales, 64 grayscales, 128 grayscales, 160 grayscales, 192 grayscales, 224 grayscales and 255 grayscales.

Referring to FIGS. 11 and 12, the spot correcting data storing part 320 stores the spot correcting data SCD. For example, the spot correcting data storing part 320 may be a Synchronous Dynamic Random Access Memory (SDRAM). Alternatively, the spot correcting data storing part 320 may be an Electrically Erasable Programmable Read-Only Memory (EEPROM). Thus, the spot correcting data storing part 320 may be a nonvolatile memory. The spot correcting data storing part 320 stores a correcting data for the K reference grayscales, and thus a data capacity of the spot correcting data storing part 320 may be decreased.

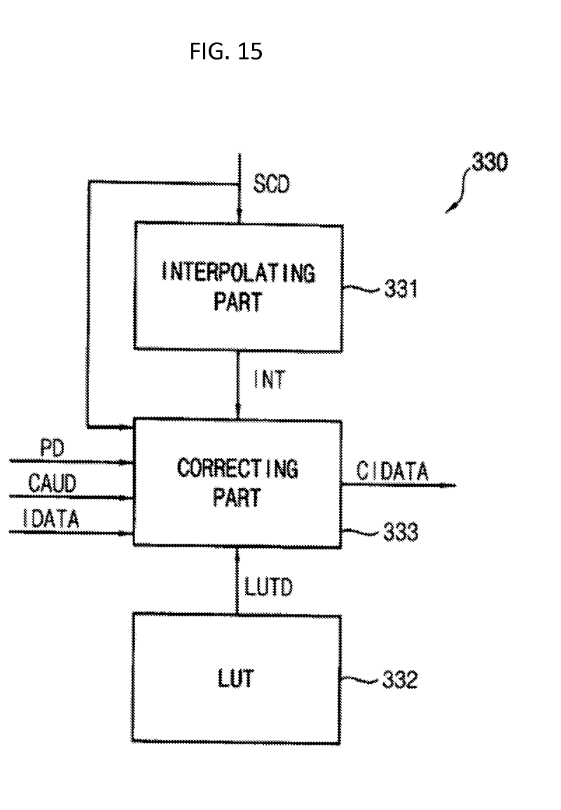

FIG. 15 is a block diagram illustrating the spot correcting part 330 of FIG. 12.

Referring to FIGS. 11, 12 and 15, the spot correcting part 330 includes an interpolating part 331, a lookup table 332 and a correcting part 333.

The interpolating part 331 receives the spot correcting data SCD and outputs an interpolating data INT. Specifically, the interpolating part 331 outputs a correcting data for grayscales not the K reference grayscales using the correcting data for the K reference grayscales with an interpolation method.

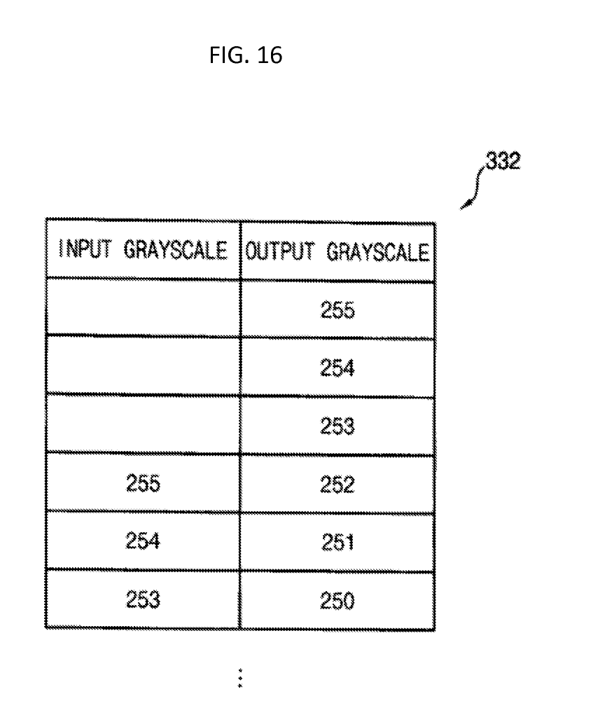

FIG. 16 is a chart illustrating the lookup table 332 of FIG. 15.

Referring to FIGS. 11, 12, 15 and 16, the lookup table 332 stores an input grayscale data and an output grayscale data. When an input grayscale of the input grayscale data is equal to or less than W grayscale which is a white grayscale, an output grayscale of the output grayscale data may be (the input grayscale−X (X is a natural number) grayscale. For example, W may be 255 and X may be 3. Although the output grayscale is less than the input grayscale, a grayscale of the image displayed on the display panel 110 may correspond to the input grayscale by increasing the data driving voltage AVDD provided to the data driving part 140 of FIG. 1. In addition, the output grayscale data further includes (W−X)+1 to W grayscales.

The correcting part 333 receives the image data IDATA including the spot 372, the position data PD designating the position of the spot 372, the correcting area unit data CAUD of the spot 372, the spot correcting data SCD, the interpolating data INT and lookup table data LUTD of the lookup table 332, corrects the spot 372 using the position data PD, the correcting area unit data CAUD, the spot correcting data SCD, the interpolating data INT and the lookup table data LUTD, and outputs a corrected image data CIDATA generated by correcting the spot 372. The correcting part 333 may increase or decrease the grayscale of the spot 372 using the spot correcting data SCD and the interpolating data INT in order to equalize a grayscale of an area where the spot 372 is disposed to a grayscale of a peripheral area of the spot 372.

When the input grayscale of the image input to the display panel 110 is the white grayscale and the grayscale of the image decreases due to the spot 372, the correcting data SCD may not be added to the input grayscale. In this case, the correcting part 333 may correct the image data IDATA using the white grayscale of the output grayscale data among the lookup table data LUTD stored in the lookup table 332.

In addition, when the input grayscale of the image input to the display panel 110 is close to the white grayscale and the grayscale of the image decreases due to the spot 372, the correcting data SCD may not be added to the input grayscale. In this case, the correcting part 333 may correct the image data IDATA using at least one of (W−X)+1 to (W−1) grayscales of the output grayscale data among the lookup table data LUTD stored in the lookup table 332.

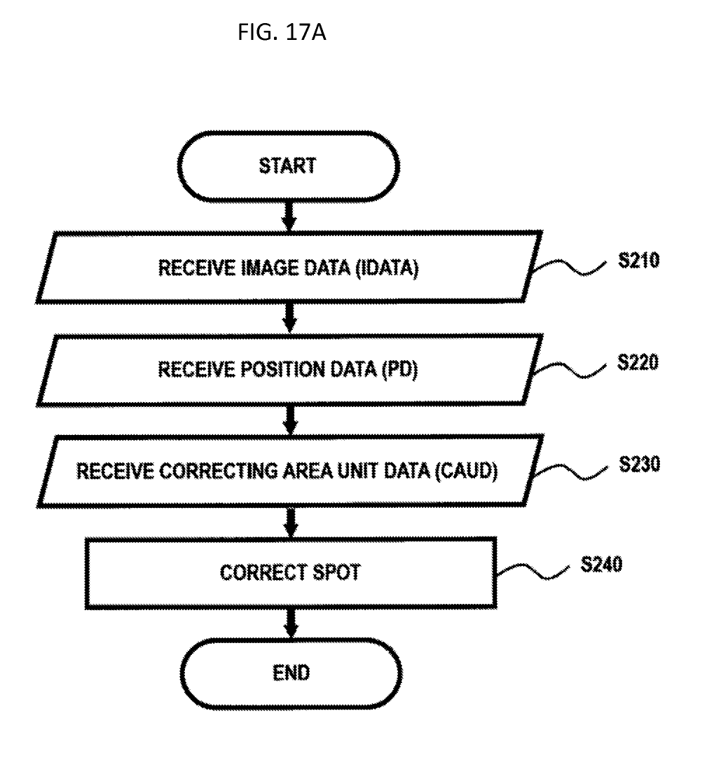

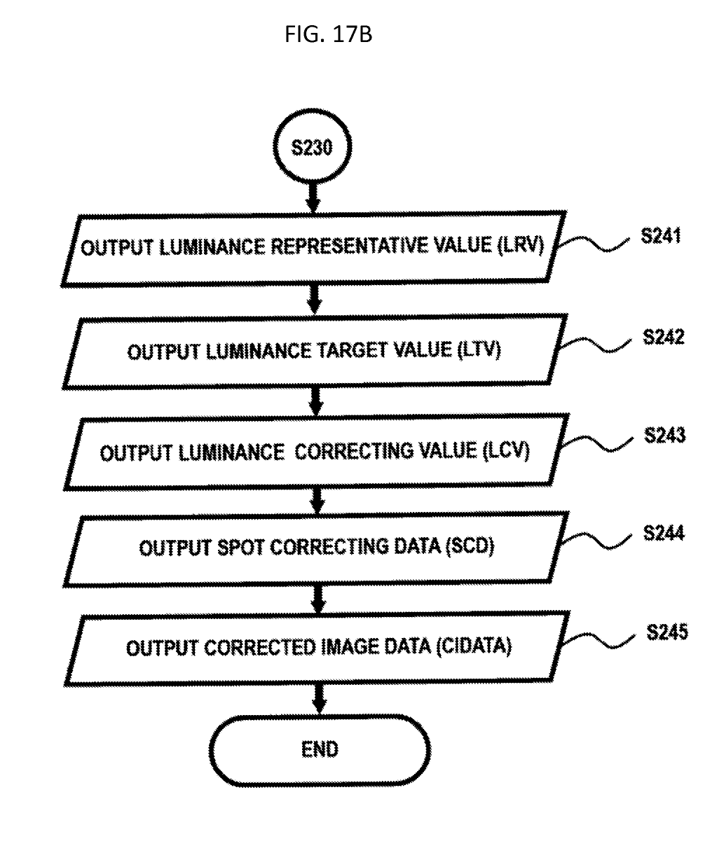

FIGS. 17A and 17B are flow charts illustrating a method of correcting a spot performed by the spot correcting apparatus 300 of FIG. 12.

Referring to FIGS. 11 to 17B, the image data IDATA is received (step S210). Specifically, the spot correcting apparatus 300 receives the image data IDATA including the spot 372.

The position data PD is received (step S220). Specifically, the spot correcting apparatus 300 receives the position data PD of the spot 372. The position data PD may designate the position of the spot 372.

The correcting area unit data CAUD is received (step S230). Specifically, the spot correcting apparatus 300 receives the correcting area unit data CAUD of the correcting area unit.

The spot 372 is corrected (step S240).

Specifically, the spot luminance profile extracting part 311 extracts the luminance profile of the spot 372 using the position data PD, the correcting area unit data CAUD and the image data IDATA, and outputs the luminance representative value LRV of the spot 372 (step S241).

The spot luminance target value calculating part 312 outputs the luminance target value LTV of the spot 372 using the luminance representative value LRV and through the two-dimensional fitting algorithm (step S242).

The spot luminance correcting value calculating part 313 receives the luminance target value LTV and the luminance representative value LRV, calculates the difference between the luminance target value LTV and the luminance representative value LRV as the luminance correcting value LCV of the spot 372, and outputs the luminance correcting value LCV (step S243).

The spot grayscale correcting value calculating part 314 outputs the spot correcting data SCD corresponding to the luminance correcting value LCV using the gamma curve (step S244). The spot correcting data SCD may be the grayscale correcting value of the spot 372. The spot correcting data SCD may include the correcting data for the K (K is a natural number not less than two) reference grayscales.

The corrected image data is output (step S245). Specifically, the interpolating part 331 receives the spot correcting data SCD and outputs the interpolating data INT which is the correcting data for the grayscales not the K reference grayscales in the interpolation method. The lookup table 332 stores the input grayscale data and the output grayscale data. When the input grayscale of the input grayscale data is equal to or less than the W grayscale which is the white grayscale, the output grayscale of the output grayscale data may be (the input grayscale −X (X is a natural number) grayscale. For example, W may be 255 and X may be 3. Although the output grayscale is less than the input grayscale, the grayscale of the image displayed on the display panel 110 may correspond to the input grayscale by increasing the data driving voltage AVDD provided to the data driving part 140 of FIG. 1. In addition, the output grayscale data further includes the (W−X)+1 to W grayscales. The correcting part 333 corrects the spot 372 using the position data PD, the correcting area unit data CAUD, the spot correcting data SCD, the interpolating data INT and the lookup table data LUTD, and outputs the corrected image data CIDATA generated by correcting the spot 372.

According to the present exemplary embodiment, a spot occurred owing to the electrical short circuit between the data line DL and the storage electrode and a spot occurred owing to the electrical short circuit between the data line DL and the shield electrode may be corrected without a repair such as a laser cutting. Thus, display quality of the display apparatus 100 may be easily improved.

According to a method of correcting a spot, a spot correcting apparatus for performing the method and a display apparatus having the spot correcting apparatus, a spot correcting performance of spots having different sizes may be improved. In addition, a spot occurred owing to an electrical short circuit between a data line and a storage electrode and a spot occurred owing to an electrical short circuit between a data line and a shield electrode may be corrected without a repair such as a laser cutting. Thus, display quality of a display apparatus may be easily improved.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. A method of correcting a spot, comprising:
correcting a first spot having a first size of a first correcting area unit of 2N*2N (N is a natural number) pixel area; and
correcting a second spot having a second size different from the first size of a second correcting area unit of L*M (each of L and M is a natural number and at least one of L and M is different from 2N) pixel area.

2. The method of claim 1, wherein the first spot has a first length longer than a length of 2N pixel area in a first direction.

3. The method of claim 1, wherein the first spot has a first width wider than a width of 2N pixel area in a second direction.

4. The method of claim 1, wherein the second size of the second spot is less than the first size of the first spot, and the second size of the second spot is less than a size of the 2N*2N pixel area.

5. The method of claim 4, wherein the second correcting area unit includes 2P*2P (P is a natural number different from N) pixel area, and the second spot has a second length longer than a length of 2P pixel area in a first direction.

6. The method of claim 4, wherein the second correcting area unit includes 2P*2P (P is a natural number different from N) pixel area, and the second spot has a second width wider than a width of 2P pixel area in a second direction.

7. The method of claim 1, further comprising:
receiving an image data including the first spot and the second spot;
receiving a first position data of the first spot and a second position data of the second spot; and
receiving a first correcting area unit data of the first correcting area unit and a second correcting area unit data of the second correcting area unit.

8. The method of claim 7, wherein the first position data designates a first center of the first spot and the second position data designates a second center of the second spot.

9. The method of claim 8, wherein the first correcting area unit data designates the first correcting area unit including four N*N pixel areas based on the first center of the first spot, and the second correcting area unit data designates the second correcting area unit including four P*P (P is a natural number different from N) pixel areas based on the second center of the second spot.

10. The method of claim 8, wherein the first correcting area unit data designates the first correcting area unit including four N*N pixel areas based on the first center of the first spot, and the second correcting area unit data designates the second correcting area unit including four Q*R (Q corresponds to L/2, and R corresponds to M/2) pixel areas based on the second center of the second spot.

11. The method of claim 1, wherein the second size of the second spot corresponds to 1*V pixel area, and the second correcting area unit corresponds to the 1*V pixel area.

12. The method of claim 11, wherein a sampling point of a luminance profile of the second spot is a peak point of a luminance profile curve.

13. The method of claim 1, further comprising:
storing input grayscale data and an output grayscale data in a lookup table.

14. The method of claim 13, wherein, when an input grayscale of the input grayscale data is equal to or less than W grayscale which is a white grayscale, an output grayscale of the output grayscale data is (the input grayscale−X (X is a natural number)) grayscale.

15. The method of claim 14, wherein the output grayscale data further includes (W−X)+1 to W grayscales.

16. A spot correcting apparatus comprising:
a first spot correcting part configured to correct a first spot having a first size of a first correcting area unit of 2N*2N (N is a natural number) pixel area; and
a second spot correcting part configured to correct a second spot having a second size different from the first size of a second correcting area unit of L*M (each of L and M is a natural number and at least one of L and M is different from 2N) pixel area.

17. The spot correcting apparatus of claim 16, wherein the second size of the second spot is less than the first size of the first spot, and the second size of the second spot is less than a size of the 2N*2N pixel area.

18. The spot correcting apparatus of claim 16, wherein the second size of the second spot corresponds to 1*V pixel area, the second correcting area unit corresponds to the 1*V pixel area, and the second spot correcting part includes a lookup table storing an input grayscale data and an output grayscale data.

19. The spot correcting apparatus of claim 18, wherein, when an input grayscale of the input grayscale data is equal to or less than W grayscale which is a white grayscale, an output grayscale of the output grayscale data is (the input grayscale−X (X is a natural number)) grayscale, and
wherein the output grayscale data further includes (W−X)+1 to W grayscales.

20. A display apparatus comprising:
a display panel including a gate line and a data line;
a gate driving part configured to output a gate signal to the gate line and drive the gate line;
a data driving part configured to output a data signal to the data line and drive the data line;
a timing controlling part configured to control a timing of the gate driving part and a timing of the data driving part; and
a spot correcting apparatus comprising a first spot correcting part correcting a first spot displayed on the display panel and having a first size of a first correcting area unit of 2N*2N (N is a natural number) pixel area, and a second spot correcting part correcting a second spot displayed on the display panel and having a second size different from the first size of a second correcting area unit of L*M (each of L and M is a natural number and at least one of L and M is different from 2N) pixel area.
